(19) United States
(12) Patent Application Publication
(10) Pub. No.: US 2014/0331815 A1
(43) Pub. Date: Nov. 13, 2014

(54) Proximity and contact sensor device in motor vehicle steering wheels

(71) Applicants: Omar Rispoli, San Vendemiano (IT); Federico Zoppas, San Vendemiano (IT)

(72) Inventors: Omar Rispoli, San Vendemiano (IT); Federico Zoppas, San Vendemiano (IT)

(73) Assignee: I.R.C.A. S.P.A. - INDUSTRIA RESISTEN-ZE CORAZZATE AFFINI, San Vendemiano (IT)

(21) Appl. No.: 14/362,193

(22) PCT Filed: Nov. 27, 2012
(86) PCT No.: PCT/EP2012/073715

§ 371 Date: Jun. 2, 2014

(30) Foreign Application Priority Data
Dec. 16, 2011 (IT) VE2011A000080

(51) Int. Cl. B62D 1/06

(52) U.S. Cl. CPC B62D 1/06
USPC 74/558

(57) ABSTRACT

A proximity and contact sensor device in motor vehicle steering wheels includes an extendable band, the length of which is slightly less than the circumference of the steering wheel and of which one surface has fixed to it at least one conductive track covered with a bi-adhesive layer, the conductive track consisting of a flat metal path obtained by treating a metal sheet applied to the extendable band, the conductive track being connected to a multi-channel capacitive sensor circuit connected by a field bus to the vehicle control unit.

### FIELD OF THE INVENTION

The present invention relates to a proximity and contact sensor device in motor vehicle steering wheels.

### BACKGROUND OF THE INVENTION

Vehicle steering wheels are known provided with a proximity and contact sensor.

A first known type of steering wheel comprises a metal wire, wrapped about the annular portion of the steering wheel and connected to a capacitive sensor. The wire is covered with a sponge layer to eliminate the drawback of poor appearance of the projecting wire, especially if leather cladding is used, the surface of which is perfectly smooth.

On the other hand, if cavities were provided on the steering wheel to house the wire, this would involve an additional cost with lost time and labour involvement to carry out the work.

Another drawback is the fact that the wire cannot be applied to the spokes.

A further drawback is the fact that the wire cannot be screened to reduce disturbances.

### SUMMARY OF THE INVENTION

The object of the invention is to provide a proximity and contact sensor device for vehicle steering wheels which does not give rise to an unpleasant outer appearance deriving from wrinkles, reliefs and deformations on the cladding materials.

This object is attained according to the invention by a proximity and contact sensor device in motor vehicle steering wheels as described hereinafter.

### BRIEF DESCRIPTION OF THE DRAWINGS

The present invention is further clarified hereinafter in the form of a preferred embodiment provided by way of non-limiting example, with reference to the accompanying drawings, in which:

FIG. 1 is a longitudinal part section through the device of the invention, and

FIG. 2 is a schematic view thereof in the form of a block diagram.

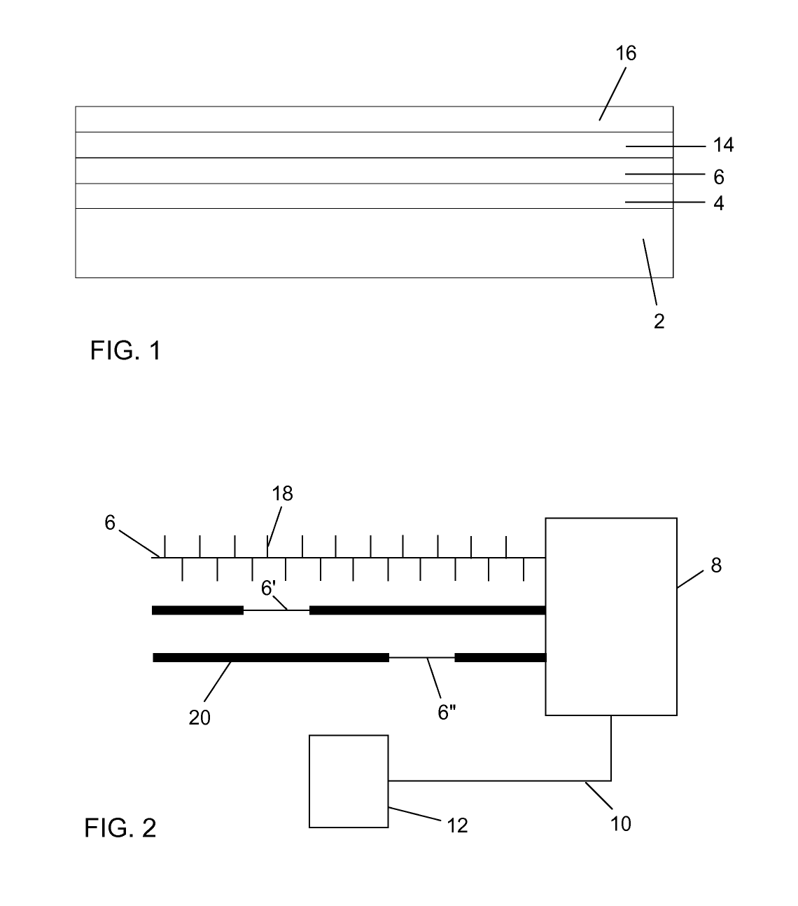

### DETAILED DESCRIPTION OF EMBODIMENTS OF THE INVENTION

As can be seen from the figures, the proximity and contact sensor device according to the invention comprises substantially a rectangular extendable band 2 of about 0.3 mm thickness, one surface of which is covered with an adhesive layer 4 on which a plurality of flat conductive tracks 6, 6′, 6″, preferably of aluminium, are applied, all connected to a capacitive multi-channel circuit 8, itself connected to the vehicle control unit 12 by a field bus 10.

The conductive tracks are covered with a second bi-adhesive layer 14 which is protected by a removable slider 16.

The tracks 6, 6′, 6″ perform the function of plates of a capacitor used as the sensitive element for proximity/contact sensing.

The conductive track 6 is formed such as to comprise a series of branches 18, whereas the tracks 6′ and 6″ are covered with an insulating material 20, with the exception of one portion.

In this manner capacitive sensing areas can be formed on the surface of the steering wheel rim for use for functions such as pushbuttons, for example for activating lights, direction indicators, etc.

In particular, the sensing system is developed on the basis of estimating the time constant required to obtain discharge of the capacitor formed by the plate present on the flexible circuit applied to the steering wheel and by that surrounding it, within an RC circuit.

From RC circuit theory it is known that if the initial state is considered to be that in which the capacitor of capacitance C is charged and presents across its ends an electrical potential difference V, then commencing its discharge through a load consisting of a resistor of ohmic value R, the voltage across the ends of the capacitor falls to about 37% of its initial value in a time τ where τ=RC. Consequently knowing the fixed resistance value R, the value of the capacitor can be estimated by measuring the time τ where C=τ/R.

On the basis of these considerations, the measurement system is able to perform the functions of charging the capacitor to a known voltage value and to discharge it through a suitably sized resistor and to measure the discharge time constant.

Consequently if the driver's hands are positioned in proximity to or in contact with the rim of the steering wheel, and hence just a few millimeters from the conductive track, a considerable increase in the equivalent conductive value thereof occurs. This is due to the fact that as the driver's body is a discrete electrical conductor, the hands act as a plate and form, together with the metal conductor of the heater, a non-ideal capacitor coupled to the vehicle metal parts.

The result is that if the driver's hands or fingers are rested on the track 6 or on the unscreened sections of the tracks 6′, 6″, they create a capacitance variation sensed by the circuit 8 which, by way of the bus 10, indicates this variation to the control unit which then causes activation of the connected function (activation of lights, direction indicators) or an emergency signal if the presence of the hands on the steering wheel is no longer sensed.

The device of the invention is formed in the following manner.

An aluminum sheet is bonded to a substantially rectangular extendable band 2 and is then subjected to silk screen printing treatment. That metal not protected by the ink is then removed to obtain continuous flat conductive tracks 6, 6′, 6″ onto which a further bi-adhesive layer 14 is applied and is covered by the liner 16.

From the aforegoing it is apparent that the contact sensor device for a steering wheel according to the invention presents numerous advantages, by virtue of the use of a conductive track obtained by the etched foil method typical of printed circuits, and in particular:

it can be easily and comfortably mounted on the steering wheel,

the cost of the aluminum track can be reckoned as only a quarter of the cost of wire conductors,

the track can be branched and therefore have several active sensing zones,

the presence of the extendable support means that no wrinkles are able to appear

it is of small thickness because of the small thickness of the conductive track,

it can be applied to the steering wheel spokes, which are then also used as a contact sensing zone,

the rear part of the track can be screened by a PVD-deposited metal to prevent disturbances.

1. A motor vehicle steering wheel with a proximity and contact sensor device comprising:
an extendable band (2), a length of which is slightly less than a circumference of the steering wheel and of which one surface has fixed thereto at least more than one conductive tracks (6, 6′, 6″) covered with a biadhesive layer (14),
said conductive tracks each consisting of a flat metal path obtained by treating a metal sheet applied to said extendable band,
said conductive tracks being connected to a multi-channel capacitive sensor circuit (8) connected by a field bus (10) to a vehicle control unit (12).

2. The motor vehicle steering wheel as claimed in claim 1, wherein the metal sheet is an aluminum sheet.

3. The motor vehicle steering wheel as claimed in claim 1, wherein one (6) of the conductive tracks extends through the entire circumference of the steering wheel.

4. The motor vehicle steering wheel as claimed in claim 1, wherein said conductive tracks (6, 6″) are partly covered with an insulating material (20).
